(19) United States
(12) Patent Application Publication
(10) Pub. No.: US 2026/0179587 A1
(43) Pub. Date: Jun. 25, 2026

(54) STOPPER AND MUSICAL INSTRUMENT STAND

(71) Applicant: HOSHINO GAKKI CO., LTD., Nagoya (JP)

(72) Inventor: Satoshi HIRASAWA, Nagoya (JP)

(21) Appl. No.: 19/286,269

(22) Filed: Jul. 31, 2025

(30) Foreign Application Priority Data
Dec. 25, 2024 (JP) 2024-228919

(51) Int. Cl. G10D 13/10; A47B 91/04

(52) U.S. Cl. CPC G10D 13/28; A47B 91/04

(57) ABSTRACT

A stopper is attached to a leg of a musical instrument stand and comes into contact with an installation surface for the musical instrument stand. The stopper includes a first contact portion including a first contact surface that comes into contact with the installation surface, and a second contact portion including a second contact surface that comes into contact with the installation surface. The second contact portion is configured to protrude from and retract into the first contact surface. The stopper is configured such that the second contact portion always protrudes from the first contact surface in a state in which the first contact surface is not in contact with the installation surface, and the second contact surface is in contact with the installation surface in a state in which the first contact surface is in contact with the installation surface.

### CROSS-REFERENCE TO RELATED APPLICATIONS

This application is based upon and claims the benefit of priority from Japanese Patent Application No. 2024-228919, filed on Dec. 25, 2024, the entire contents of which are incorporated herein by reference.

### BACKGROUND

### 1. Field

The present disclosure relates to a stopper and a stand for a musical instrument.

### 2. Description of Related Art

Japanese Laid-Open Patent Publication No. 2007-25166 discloses a snare drum stand for supporting a snare drum. The snare drum stand includes a basket to which a snare drum is attached, and a stand body that supports the basket. The stand body includes a main pipe and multiple leg plates foldably attached to the main pipe. A rubber stopper that comes into contact with the installation surface for the snare drum stand is attached to the distal end of each leg plate.

In the snare drum stand disclosed in Japanese Laid-Open Patent Publication No. 2007-25166, displacement of the snare drum stand relative to the installation surface is reduced by the stoppers attached to the respective leg plates. However, when an impact is applied by the player, the snare drum stand may be momentarily lifted off the floor surface due to the impact, resulting in movement of the stand. In such a case, the position of the snare drum relative to the player changes, making it more difficult for the player to play the snare drum. This issue is not limited to snare drum stands, but also arises in various types of musical instrument stands such as cymbal stands configured to support cymbals. Therefore, there is room for improvement in reducing movement of the musical instrument stand when the musical instrument is being played.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a stopper is attached to a leg of a musical instrument stand and configured to come into contact with an installation surface for the musical instrument stand. The stopper includes a first contact portion including a first contact surface that comes into contact with the installation surface, and a second contact portion including a second contact surface that comes into contact with the installation surface. The second contact portion is configured to protrude from and retract into the first contact surface. The stopper is configured such that the second contact portion always protrudes from the first contact surface in a state in which the first contact surface is not in contact with the installation surface, and the second contact surface is in contact with the installation surface in a state in which the first contact surface is in contact with the installation surface.

In another general aspect, a musical instrument stand includes a stopper attached to a leg of the musical instrument stand and configured to come into contact with an installation surface for the musical instrument stand. The stopper includes a first contact portion including a first contact surface that comes into contact with the installation surface, and a second contact portion including a second contact surface that comes into contact with the installation surface. The second contact portion is configured to protrude from and retract into the first contact surface. The stopper is configured such that the second contact portion always protrudes from the first contact surface in a state in which the first contact surface is not in contact with the installation surface, and the second contact surface is in contact with the installation surface in a state in which the first contact surface is in contact with the installation surface.

Other features and aspects will be apparent from the following detailed description, the drawings, and the claims.

### BRIEF DESCRIPTION OF THE DRAWINGS

FIG. 1 is a perspective view of a musical instrument stand.

FIG. 2 is a cross-sectional view of a stopper.

FIG. 3 is a cross-sectional view taken along line 3-3 of FIG. 2.

FIG. 4 is a bottom view of the stopper.

FIG. 5 is a cross-sectional view of the stopper in a state in which a second contact portion protrudes from a first contact surface.

FIG. 6 is a cross-sectional view of the stopper in a state in which a first contact portion and the second contact portion are in contact with the installation surface.

FIG. 7 is a bottom view of a stopper according to a first modification.

FIG. 8 is a bottom view of a stopper according to a second modification.

FIG. 9 is a side view of the stopper according to the second modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

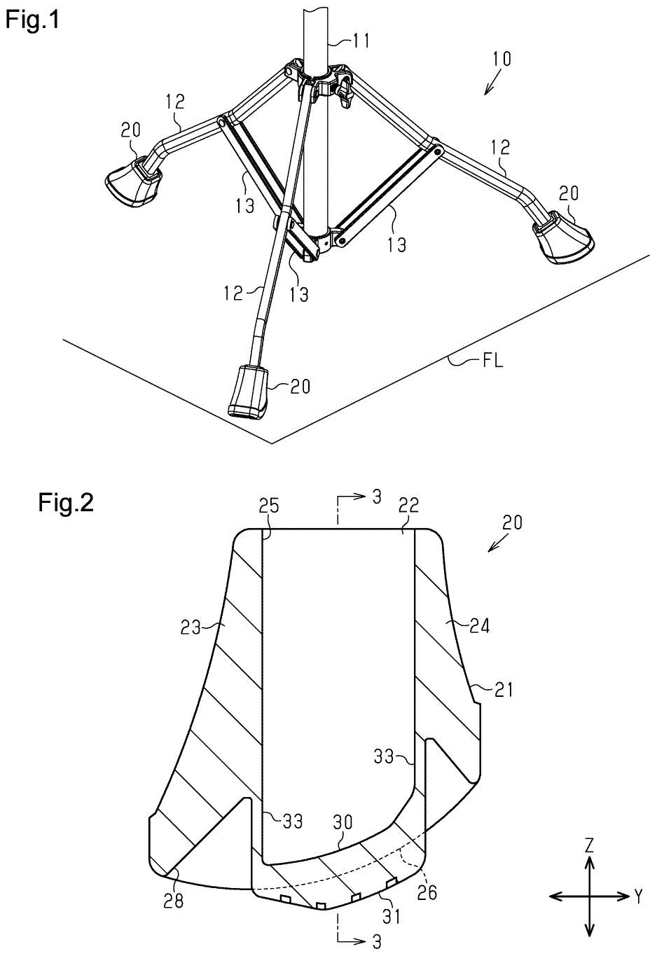

A stopper and a musical instrument stand according to an embodiment will now be described with reference to FIGS. 1 to 6.

### Configuration of Musical Instrument Stand

As shown in FIG. 1, a musical instrument stand (hereinafter, referred to as a stand 10) includes a support column 11 extending in a vertical direction, three legs 12 extending from the support column 11, and three stays 13 connecting the three legs 12 to the support column 11 in a foldable manner. The column 11 supports a percussion instrument (not shown) such as a snare drum or a cymbal.

The stand 10 is provided with three stoppers 20 respectively attached to the distal ends of the three legs 12. The stoppers 20 restrict movement of the stand 10 by coming into contact with an installation surface FL for the stand 10.

### Overall Configuration of the Stoppers 20

As shown in FIG. 2, each stopper 20 includes a first contact portion 21, a second contact portion 30, and two movable portions 33. The first contact portion 21, the second contact portion 30, and the two movable portions 33 are integrally formed of rubber.

In the following description, directions extending along an X-axis, a Y-axis, and a Z-axis shown in some of the drawings are referred to as an X-axis direction, a Y-axis direction, and a Z-axis direction, respectively. The X-axis direction, the Y-axis direction, and the Z-axis direction are orthogonal to each other. For illustrative purposes, the Z-axis direction is assumed to correspond to the vertical direction in the following description of the stopper 20.

### Configuration of the First Contact Portion 21

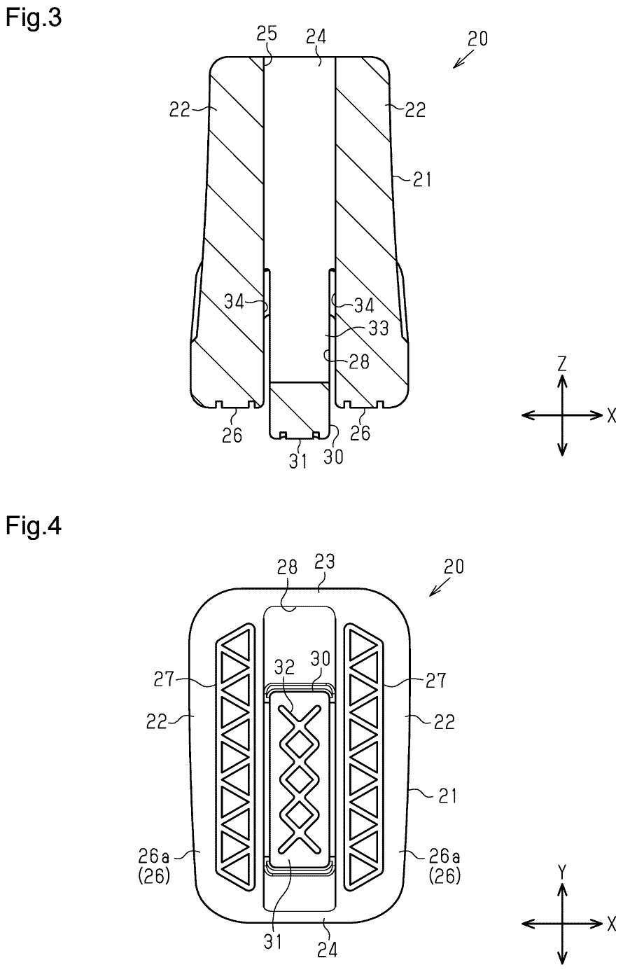

As shown in FIGS. 2 and 3, the first contact portion 21 includes two side walls 22, a front wall 23, and a rear wall 24. The two side walls 22 face each other in the X-axis direction and extend in parallel with each other in the Z-axis direction. The front wall 23 connects first ends of the two side walls 22 to each other in the Y-axis direction. The rear wall 24 connects second ends, opposite to the first ends, of the two side walls 22 to each other. The outer surface of the front wall 23 and the outer surface of the rear wall 24 extend such that the distance therebetween in the Y-axis direction increases toward the lower side.

The first contact portion 21 includes an accommodating recess 25 for accommodating the distal end of the leg 12. The accommodating recess 25 extends in the Z-axis direction and opens in an upper surface of the first contact portion 21. The accommodating recess 25 is defined by the two side walls 22, the front wall 23, and the rear wall 24. The opening of the accommodating recess 25 has a rectangular shape elongated in the Y-axis direction when viewed from above.

As shown in FIG. 4, the first contact portion 21 includes a first contact surface 26 that comes into contact with the installation surface FL. The first contact surface 26 forms a lower surface of the stopper 20, more specifically, a lower surface of each side wall 22. The area of the first contact surface 26 is greater than the area of a second contact surface 31, which will be discussed below.

Groove patterns defined by multiple grooves 27 are formed in the first contact surface 26. These groove patterns of the first contact surface 26 function as an anti-slip feature for the stopper 20.

As shown in FIGS. 2 and 6, the first contact surface 26 is arcuately curved so as to be convex downward. When the stopper 20 contacts the installation surface FL, a part of the first contact surface 26 comes into contact with the installation surface FL. The contact location between the first contact surface 26 and the installation surface FL varies depending on the orientation of the three legs 12 relative to the support column 11.

As shown in FIGS. 2 and 3, the first contact portion 21 includes a recess 28 that opens in the first contact surface 26. The recess 28 opens in a central portion of the first contact surface 26 in the X-axis direction. The recess 28 and the accommodating recess 25 are continuous with each other in the Z-axis direction. The recess 28 is defined by the two side walls 22, the front wall 23, and the rear wall 24. The opening of the recess 28 has a rectangular shape elongated in the Y-axis direction when viewed from below. As shown in FIG. 2, the inner surface of the front wall 23 and the inner surface of the rear wall 24, which define the recess 28, spread away from each other in the Y-axis direction as they extend toward the lower ends. Therefore, the dimension of the recess 28 in the Y-axis direction gradually increases toward the lower side.

As shown in FIG. 4, the first contact surface 26 includes two contact regions 26a. The two contact regions 26a are located on the opposite sides of the opening of the recess 28 in the X-axis direction. The areas of the two contact regions 26a are equal.

### Configuration of the Second Contact Portion 30

As shown in FIG. 2, the second contact portion 30 is accommodated in the recess 28. The second contact portion 30 has a substantially rectangular parallelepiped shape elongated in the Y-axis direction. The second contact portion 30 is configured to protrude from and retract into the first contact surface 26. The second contact portion 30 includes the second contact surface 31 that comes into contact with the installation surface FL. The second contact surface 31 forms the lower surface of the stopper 20. The second contact surface 31 is arcuately curved so as to be convex downward. The second contact surface 31 extends along the first contact surface 26.

As shown in FIG. 3, the dimension of the second contact portion 30 in the X-axis direction is smaller than the dimension of the opening of the recess 28 in the X-axis direction. Accordingly, the second contact portion 30 is not in contact with the two side walls 22.

As shown in FIG. 4, a groove pattern defined by multiple grooves 32 is formed in the second contact surface 31. This groove pattern of the second contact surface 31 functions as an anti-slip feature for the stopper 20. The groove pattern of the second contact surface 31 is different from the groove pattern of the first contact surface 26.

### Configuration of the Movable Portion 33

As shown in FIG. 2, the two movable portions 33 connect the first contact portion 21 to the second contact portion 30. Specifically, the two movable portions 33 respectively connect two sections of the inner surface of the recess 28 that face each other in the Y-axis direction to two sections of the second contact portion 30 that are located on the opposite sides of the central portion of the second contact portion 30 in the Y-axis direction. Therefore, the two movable portions 33 are connected to the front wall 23 and the rear wall 24, respectively.

The two movable portions 33 extend in parallel with each other in the direction of the central axis of the accommodating recess 25, that is, in the Z-axis direction. The two movable portions 33 extend so as to be inclined with respect to both a planar direction of the second contact surface 31 and a direction orthogonal to the planar direction. The movable portion 33 has the shape of a flat plate having a thickness in the Y-axis direction.

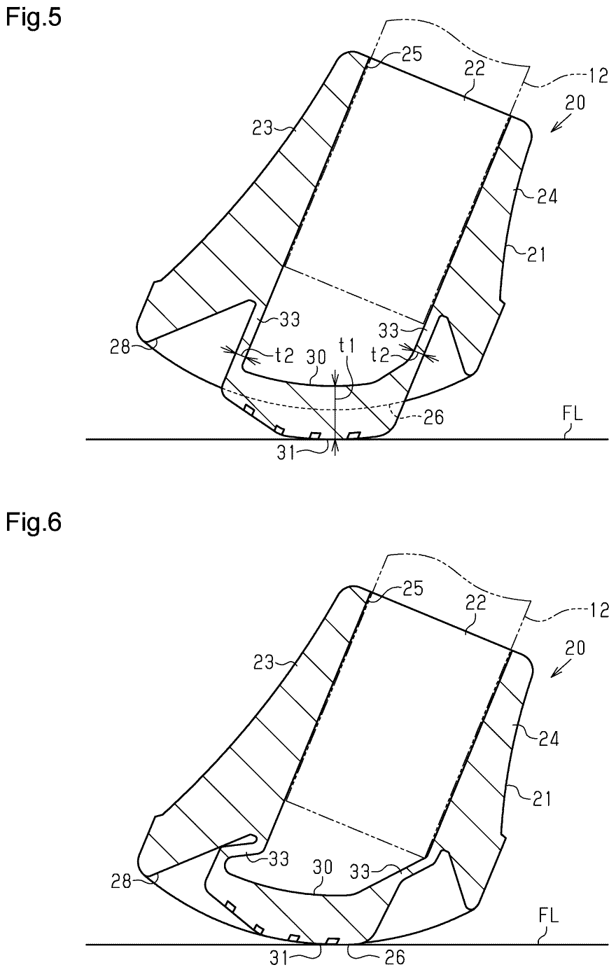

As shown in FIG. 5, a thickness t1 of the second contact portion 30 in the vertical direction, more specifically, the thickness t1 of the second contact portion 30 in a direction orthogonal to the second contact surface 31, is greater than a thickness t2 of the movable portion 33. The thickness t1 varies depending on the position in the Y-axis direction in the second contact portion 30, but the minimum value of the thickness t1 is greater than the thickness t2.

As shown in FIG. 3, the dimension of each movable portion 33 in the X-axis direction is equal to the dimension of the second contact portion 30 in the X-axis direction. A slit 34 is formed between each movable portion 33 and each of the two side walls 22. Therefore, each movable portion 33 is not in contact with the two side walls 22.

As shown in FIG. 2, the lengths of the two movable portions 33 are set to such lengths that the second contact portion 30 protrudes from the recess 28. Accordingly, the second contact portion 30 always protrudes from the first contact surface 26 when the first contact surface 26 is not in contact with the installation surface FL. At this time, part of the second contact portion 30 is located inside the recess 28.

As shown in FIGS. 5 and 6, the two movable portions 33 are elastically deformed when the second contact portion 30 retracts into the recess 28. Specifically, when the stand 10 is placed on the installation surface FL and the second contact portion 30 is pressed against the installation surface FL, the two movable portions 33 are elastically deformed by buckling in the same direction. As a result of this elastic deformation of the movable portions 33, the second contact portion 30 retracts into the recess 28. The second contact portion 30 retracts until the second contact surface 31 is positioned flush with the first contact surface 26, thereby allowing the first contact surface 26 to contact the installation surface FL. Accordingly, when the first contact surface 26 is in contact with the installation surface FL, the second contact surface 31 is also in contact with the installation surface FL. In this state, the entirety of the second contact portion 30 is located inside the recess 28.

### Operation of the Present Embodiment

As shown in FIG. 6, in a state in which the stand 10 is installed on the installation surface FL, both the first contact surface 26 and the second contact surface 31 of the second contact portion 30, which retracts into the recess 28, are in contact with the installation surface FL. When a percussion instrument supported by the stand 10 is struck by a player in this state, the impact generated by the strike may lift the stand 10 off the installation surface FL. In such a case, as shown in FIG. 5, if the first contact portion 21 of the stopper 20 is lifted off the installation surface FL due to the impact, the restoring force of the elastically deformed movable portions 33 causes the second contact portion 30 to protrude toward the installation surface FL from the first contact surface 26. As a result, the second contact surface 31 remains in contact with the installation surface FL. Therefore, even if the first contact portion 21 is lifted off the installation surface FL, the stopper 20 remains in contact with the installation surface FL.

### Advantages of the Present Embodiment

(1) The second contact portion 30 always protrudes from the first contact surface 26 when the first contact surface 26 is not in contact with the installation surface FL. In a state in which the first contact surface 26 is in contact with the installation surface FL, the second contact surface 31 is also in contact with the installation surface FL.

With this configuration, in a state in which the first contact surface 26 of the first contact portion 21 is not in contact with the installation surface FL, the second contact portion 30 always protrudes from the first contact surface 26. In a state in which the first contact surface 26 is in contact with the installation surface FL, the second contact surface 31 of the second contact portion 30 is also in contact with the installation surface FL. Accordingly, when the first contact portion 21 is lifted off the installation surface FL due to an impact when the player plays the percussion instrument, the second contact portion 30 protrudes from the first contact surface 26 and comes into contact with the installation surface FL, so that the movement of the stand 10 is restricted. Therefore, it is possible to limit the movement of the stand 10 when the percussion instrument is played.
(2) In a state in which the first contact surface 26 is in contact with the installation surface FL, the second contact surface 31 of the second contact portion 30, which retracts into the recess 28, is in contact with the installation surface FL.

With this configuration, since the second contact portion 30 retracts into the recess 28, the second contact surface 31 also readily comes into contact with the installation surface FL when the first contact surface 26 is in contact with the installation surface FL.
(3) The stopper 20 includes the movable portions 33, which are elastically deformed when the second contact portion 30 retracts into the recess 28.

As a result of this elastic deformation of the movable portions 33, the second contact portion 30 retracts into the recess 28. Thus, in a state in which both the first contact surface 26 and the second contact surface 31 are in contact with the installation surface FL, the second contact surface 31 of the second contact portion 30, which is receiving the restoring force of the movable portions 33, is in contact with the installation surface FL. Accordingly, when the first contact portion 21 is lifted off the installation surface FL, the second contact portion 30 protrudes from the inside of the recess 28 due to the restoring force of the movable portions 33, so that the second contact surface 31 readily comes into contact with the installation surface FL.
(4) The first contact surface 26 includes the two contact regions 26a, which are located on the opposite sides of the opening of the recess 28.

With this configuration, the second contact portion 30 protrudes from the recess 28 that opens between the two contact regions 26a. Therefore, in a state in which the second contact portion 30 retracts into the recess 28, the second contact portion 30 is less likely to be visually recognized from the outside. This configuration prevents the appearance of the stopper 20 from being impaired.
(5) The first contact portion 21, the second contact portion 30, and the movable portions 33 are integrally formed of rubber.

This configuration prevents the configuration of the stopper 20 from being complicated as compared to a case in which the first contact portion 21, the second contact portion 30, and the movable portion 33 are separate components.

In addition, this configuration increases the frictional force generated between the second contact surface 31 and the installation surface FL as compared to a case in which the first contact portion 21 and the second contact portion 30 are formed of a hard material.
(6) The two movable portions 33 respectively connect two sections of the inner surface of the recess 28 that face each to two sections of the second contact portion 30 that are located on the opposite sides of the central portion of the second contact portion 30.

With this configuration, the inner surface of the recess 28 and the second contact portion 30 are connected by the two movable portions 33. This configuration stabilizes the movement of the second contact portion 30 when it protrudes from or retracts into the first contact surface 26. This reliably limits movement of the stand 10.
(7) The two movable portions 33 extend so as to be inclined with respect to both a planar direction of the second contact surface 31 and a direction orthogonal to the planar direction.

With this configuration, when the second contact portion 30 retreats into the recess 28, the second contact portion 30 is likely to receive a force that elastically deforms the movable portions 33. This allows the second contact portion 30 to smoothly retract into the recess 28.
(8) The thickness t1 of the second contact portion 30 in the vertical direction is greater than the thickness t2 of the movable portion 33.

With this configuration, the movable portions 33 deform elastically prior to the second contact portion 30 during retraction of the second contact portion 30 into the recess 28. This configuration stabilizes the movement of the second contact portion 30 when it is protrudes from or retracts into the first contact surface 26.
(9) The area of the first contact surface 26 is greater than the area of the second contact surface 31.

With this configuration, the surface area of the first contact surface 26, which bears the weight of the stand 10, is greater than that of the second contact surface 31. This improves the stability of the stand 10 in a state in which both the first contact surface 26 and the second contact surface 31 are in contact with the installation surface FL.

### Modifications

The above-described embodiment may be modified as follows. The above-described embodiment and the following modifications can be combined as long as the combined modifications remain technically consistent with each other.

The stand 10 may include at least one leg 12 and at least one stopper 20 attached to the leg 12.

The stand 10 may support a percussion instrument different from a snare drum or a cymbal, or may support a musical instrument other than a percussion instrument.

The area of the first contact surface 26 may be less than or equal to the area of the second contact surface 31.

The groove pattern may be omitted from either the first contact surface 26 or the second contact surface 31, or from both surfaces.

The thickness t1 of the second contact portion 30 in the vertical direction may be less than or equal to the thickness t2 of the movable portion 33.

The two movable portions 33 may extend in a direction orthogonal to the planar direction of the second contact surface 31.

The two movable portions 33 does not need to extend in parallel with each other. That is, the inclination angles of the two movable portions 33 with respect to the planar direction of the second contact surface 31 may be different from each other.

The stopper 20 may include a single movable portion 33 or three or more movable portions 33.

At least one of the first contact portion 21 and the second contact portion 30 may be formed of a material different from rubber, such as a hard resin material. In this case, the first contact portion 21, the second contact portion 30, and the movable portion 33 may be formed as separate components.

The movable portions 33 may be elastic bodies separate from the first contact portion 21 and the second contact portion 30, such as leaf springs or coil springs.

The second contact portion 30 may constantly protrude from the first contact surface 26 under its own weight when the first contact surface 26 is not in contact with the installation surface FL. In this case, the movable portions 33 do not need to elastically deform when the second contact portion 30 retracts into the recess 28. Such movable portions 33 may, for example, be configured to connect the first contact portion 21 to the second contact portion 30, and to be slidable in the vertical direction relative to the first contact portion 21.

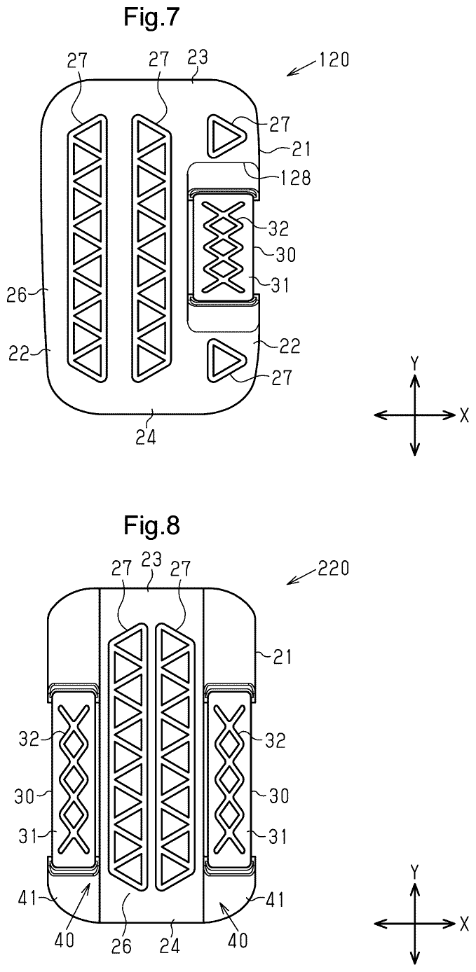

As shown in FIG. 7, the first contact portion 21 may have, instead of the recess 28, a groove-shaped recess 128 that opens in the outer surface of one of the side walls 22 and the lower surface of the first contact surface 26. In the stopper 120 of the present modification, the movable portions 33 and the second contact portion 30 are exposed to the outside. The recess 128 of the present modification is continuous with the accommodating recess 25. Recesses 128 may be provided on the opposite sides of the first contact portion 21 in the X-axis direction.

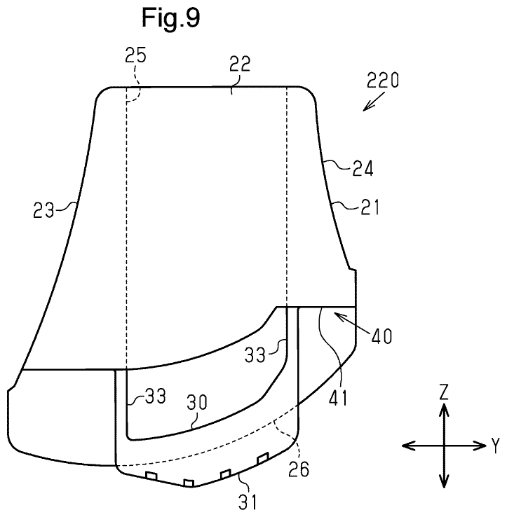

As shown in FIG. 8, the first contact portion 21 may include, instead of the recess 28, two cutouts 40 formed at opposite corner portions in the X-axis direction on the lower surface of the first contact portion 21. Each cutout 40 extends over the entire first contact portion 21 in the Y-axis direction. As shown in FIG. 9, the inner surface of each cutout 40 includes a facing surface 41 that is located above the first contact surface 26 and faces the installation surface FL. In the first contact portion 21, a step is formed by the first contact surface 26 and each facing surface 41. Two movable portions 33 are connected to the facing surface 41 of each cutout 40. Therefore, the movable portions 33 and the second contact portion 30 are exposed to the outside. In the stopper 220 of the present modification, a structure including the cutout 40, the movable portion 33, and the second contact portion 30 is provided at both ends in the X-axis direction. This structure may be provided only at one end portion of the stopper 220 in the X-axis direction, or may be provided at one end or both ends in the Y-axis direction.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A stopper attached to a leg of a musical instrument stand and configured to come into contact with an installation surface for the musical instrument stand, the stopper comprising:
a first contact portion including a first contact surface that comes into contact with the installation surface; and
a second contact portion including a second contact surface that comes into contact with the installation surface, the second contact portion being configured to protrude from and retract into the first contact surface, wherein
the stopper is configured such that
the second contact portion always protrudes from the first contact surface in a state in which the first contact surface is not in contact with the installation surface, and
the second contact surface is in contact with the installation surface in a state in which the first contact surface is in contact with the installation surface.

2. The stopper according to claim 1, wherein
the first contact portion includes a recess that opens in the first contact surface and accommodates the second contact portion, and
the stopper is configured such that, in a state in which the first contact surface is in contact with the installation surface, the second contact surface of the second contact portion retracted in the recess is in contact with the installation surface.

3. The stopper according to claim 2, further comprising a movable portion that is elastically deformed when the second contact portion retracts into the recess.

4. The stopper according to claim 2, wherein the first contact surface includes two contact regions located on opposite sides of an opening of the recess.

5. The stopper according to claim 1, wherein the second contact portion is formed of rubber.

6. The stopper according to claim 3, wherein the first contact portion, the second contact portion, and the movable portion are integrally formed of rubber.

7. The stopper according to claim 6, wherein the movable portion is one of two movable portions, and the two movable portions respectively connect two sections of an inner surface of the recess that face each other to two sections of the second contact portion that are located on opposite sides of a central portion of the second contact portion.

8. The stopper according to claim 7, wherein the two movable portions extend so as to be inclined with respect to both a planar direction of the second contact surface and a direction orthogonal to the planar direction.

9. The stopper according to claim 6, wherein
the movable portion has a shape of a plate, and
a thickness of the second contact portion in a vertical direction is greater than a thickness of the movable portion.

10. The stopper according to claim 1, wherein an area of the first contact surface is greater than an area of the second contact surface.

11. A musical instrument stand comprising a stopper attached to a leg of the musical instrument stand and configured to come into contact with an installation surface for the musical instrument stand, wherein
the stopper includes:
a first contact portion including a first contact surface that comes into contact with the installation surface; and
a second contact portion including a second contact surface that comes into contact with the installation surface, the second contact portion being configured to protrude from and retract into the first contact surface, and
the stopper is configured such that
the second contact portion always protrudes from the first contact surface in a state in which the first contact surface is not in contact with the installation surface, and
the second contact surface is in contact with the installation surface in a state in which the first contact surface is in contact with the installation surface.
